(19) United States
(12) Patent Application Publication
(10) Pub. No.: US 2026/0156630 A1
(43) Pub. Date: Jun. 4, 2026

(54) WI-FI ACCESS POINT FOR INDUSTRIAL AND CONSUMER INTERNET OF THINGS

(71) Applicant: MaxLinear, Inc., Carlsbad, CA (US)

(72) Inventor: Saju Palayur, Poway, CA (US)

(73) Assignee: MaxLinear, Inc., Carlsbad, CA (US)

(21) Appl. No.: 19/405,321

(22) Filed: Dec. 1, 2025

Related U.S. Application Data
(60) Provisional application No. 63/726,657, filed on Dec. 1, 2024.

(51) Int. Cl. H04W 72/0453; H04L 5/00; H04W 12/03; H04W 72/0457

(52) U.S. Cl. CPC H04W 72/0453; H04L 5/0053; H04W 12/03; H04W 72/0457

(57) ABSTRACT

An access point (AP) may include a transceiver and a processing device. The transceiver may be operable to facilitate communications with a station (STA). The processing device may be operable to allocate first bandwidth in a first operating band and second bandwidth in a second operating band to the STA. The processing device may also be operable to switch traffic to the STA between the first operating band and the second operating band. The first operating band may be one or more of a 2.4 GHz band, a 5 GHz band, or a 6 GHz band. The second operating band may be one or more of a 2.4 GHz band, a 5 GHz band, or a 6 GHz band. The first operating band may be different from the second operating band.

### CROSS REFERENCE TO RELATED APPLICATIONS

This U.S. Patent Application claims priority to U.S. Provisional Patent Application No. 63/726,657, titled “WI-FI ACCESS POINT FOR INDUSTRIAL AND CONSUMER INTERNET OF THINGS,” and filed on Dec. 1, 2024, the disclosure of which is hereby incorporated by reference in its entirety.

### TECHNICAL FIELD

This disclosure generally relates to wireless communication and networking, and more specifically, to a Wi-Fi® access point for industrial and consumer internet of things.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, an access point (AP) may include a transceiver and a processing device. The transceiver may be operable to facilitate communications with a station (STA). The processing device may be operable to allocate first bandwidth in a first operating band and second bandwidth in a second operating band to the STA. The processing device may also be operable to switch traffic to the STA between the first operating band and the second operating band. The first operating band may be one or more of a 2.4 GHz band, a 5 GHz band, or a 6 GHz band. The second operating band may be one or more of a 2.4 GHz band, a 5 GHz band, or a 6 GHz band. The first operating band may be different from the second operating band.

In another embodiment, a station (STA) may include a transceiver and a processing device. The transceiver may be operable to facilitate communications with an access point (AP). The processing device may be operable to connect to a first operating band and to a second operating band associated with the AP. The processing device may also be operable to select a packet from one or more of the first operating band or the second operating band based on performance of the communications. The first operating band may be one or more of a 2.4 GHz band, a 5 GHz band, or a 6 GHZ band. The second operating band may be one or more of a 2.4 GHz band, a 5 GHz band, or a 6 GHz band. The first operating band may be different from the second operating band.

In another embodiment, a method may include allocating, at an access point (AP), first bandwidth in a first operating band and second bandwidth in a second operating band to a station (STA). The method may also include switching, at the AP, traffic to the STA between the first operating band and the second operating band. The first operating band may be one or more of a 2.4 GHz band, a 5 GHz band, or a 6 GHz band. The second operating band may be one or more of a 2.4 GHz band, a 5 GHz band, or a 6 GHz band. The first operating band may be different from the second operating band.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example system for a Wi-Fi® access point for industrial and consumer internet of things;

FIG. 2 illustrates a flowchart of an example method for a Wi-Fi® access point for industrial and consumer internet of things;

FIG. 3 illustrates a flowchart of another example method for a Wi-Fi® access point for industrial and consumer internet of things;

FIG. 4 illustrates a block diagram of an example communication system for a Wi-Fi® access point for industrial and consumer internet of things; and

FIG. 5 illustrates an example computing device.

### DETAILED DESCRIPTION

In some industrial and/or consumer environments, reliable and secure wireless connectivity may be used for real-time monitoring, control, entertainment, and automation. Previous approaches often lacked flexibility, security, and/or performance that may be needed to meet the diverse demands of dense internet of things (IOT) deployments and operations.

An advanced Wi-Fi® access point (AP) may combine multi-band connectivity, intelligent failover systems, and/or enhanced security mechanisms. In some instances, the advanced AP described herein may be designed for applications ranging from industrial IoT to consumer smart homes. Such AP may contribute to seamless operation in varied conditions.

The AP is a next-generation Wi-Fi® access point designed for high-reliability and low-latency connectivity in diverse environments. The access point may integrate hardware and software features to support simultaneous multi-band communication, intelligent traffic management, and multi-layered security, including end-to-end encryption.

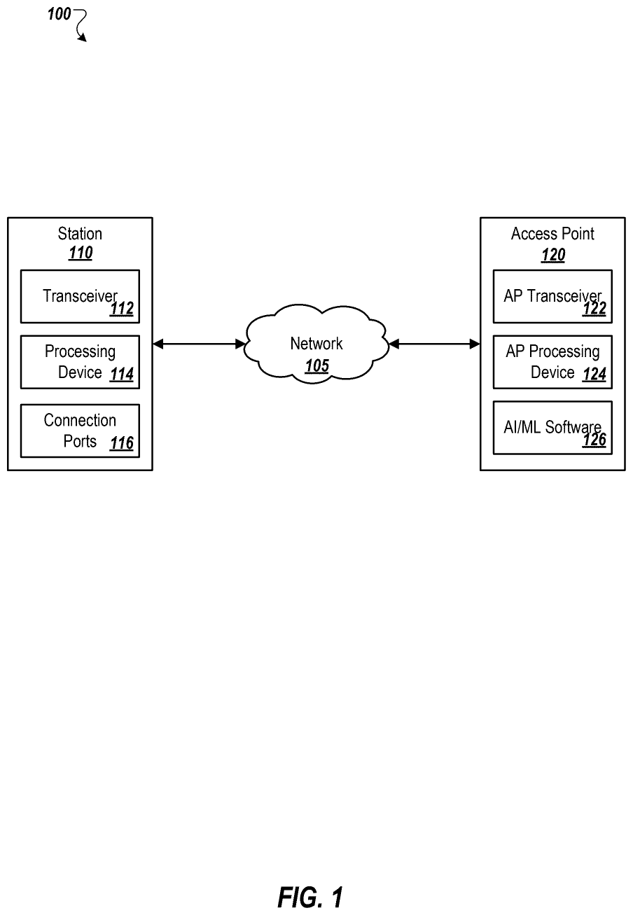

FIG. 1 illustrates an example system 100 for Wi-Fi® access point for industrial and consumer internet of things. The system 100 may include a network 105, a station (STA) 110, and an access point (AP) 120. The STA 110 may include a transceiver 112, a processing device 114, and connection ports 116. The AP 120 may include an AP transceiver 122, an AP processing device 124, and artificial intelligence/machine learning (AI/ML) software 126.

In some instances, the network 105 may be a wireless network, such as a WLAN. The network 105 may support wireless communications between connected devices using a mutually supported standard, such as 802.11a, 802.11b, 801.11g, 802.11n (Wi-Fi® 4), 802.11ac (Wi-Fi® 5), 802.11ax (Wi-Fi® 6), and so forth. As illustrated, the STA 110 may connect to the AP 120 via the network 105. The STA 110 may include any number of antennas and/or configuration of the antennas. For example, the transceiver 112 of the STA 110 may include a TX antenna, an RX antenna, a 2×2.4 GHz antenna, and/or a 5 GHz antenna. In another example, the transceiver 112 may include two 2.4 GHz antennas and two 5 GHz/6 GHz antennas. In another example, the transceiver 112 may include a 2×2.4 GHz antenna and a 2×5 GHz/6 GHz antenna, which may support low power operations for at least some operating bands. Alternatively, or additionally, multiple transceivers may be included in the STA 110, such as a first, 4×2.4 GHz transceiver and a second, 4×5 GHz transceiver.

In some instances, the AP processing device 124 may allocate first bandwidth in a first operating band and second bandwidth in a second operating band to the STA 110. The first operating band may be one or more of a 2.4 GHz band, a 5 GHz band, and/or a 6 GHz band. Alternatively, or additionally, the second operating band may be one or more of a 2.4 GHz band, a 5 GHz band, and/or a 6 GHz band. In some instances, the first operating band may be different from the second operating band. The AP processing device 124 may switch, at the AP 120, traffic between the first operating band and the second operating band.

In such instances, the AP 120 may provide for simultaneous multi-band connectivity which may operate across 2.4 GHz, 5 GHz, and/or 6 GHz operating bands to provide robust and/or interference-resistant communication for connected devices. Traffic packets may be replicated on two or more operating bands (e.g., the first operating band and the second operating band), which may contribute to reliability and/or redundancy in the system 100. The AP 120 may provide for simultaneous multi-band connectivity with the STA 110 which may operate across 2.4 GHz, 5 GHz, and 6 GHz operating bands to provide robust and interference-resistant communication for connected devices. In some instances, traffic packets from the AP 120 to the STA 110 may be replicated on two or more operating bands, which may contribute to reliability and/or redundancy in the system 100. The AP 120 may dynamically allocate bandwidth and/or may switch traffic intelligently between 2.4 GHz, 5 GHz, and 6 GHz operating bands to optimize performance in high-density environments. may dynamically allocate bandwidth and switch traffic intelligently between 2.4 GHz, 5 GHz, and 6 GHz operating bands to optimize performance in high-density environments.

In some instances, the AP processing device 124 may be operable to allocate radio resources to multiple operating bands (e.g., the 2.4 GHz and 5 GHz operating bands) for redundancy, which may improve reliability in the system 100. The AP processing device 124 may switch traffic in real-time to a better-performing band in case of interference or degradation in the system 100. For example, in instances in which communications using the 2.4 GHz become congested, the AP processing device 124 may switch the traffic from the 2.4 GHz band to the 5 GHz band. In some instances, the AP 120 may provide uninterrupted communication for industrial IoT operations using high reliability by switching between any of the operating bands supported by the AP 120.

In some instances, the AP 120 may have low latency that may be optimized for real-time IoT operations, which may include advanced quality of service (QOS) and/or multi-user multiple input, multiple output (MU-MIMO) for seamless or near seamless performance. The AP 120 may have redundant connectivity (e.g., concurrent dual-band (or triple-band) support with automatic failover ensures uninterrupted operations) with the STA 110 via the AP transceiver 122 and the transceiver 112. The AP 120 may be designed to operate in harsh environments, including support for extended range, such as mesh networking. In some instances, the AP 120 may use smart management (e.g., cloud-based control, edge AI optimization, and/or remote diagnostics), which may include dual power options including power over Ethernet and/or wall-powered AC to contribute to reliable and/or seamless deployment in diverse industrial and commercial environments. The AP 120 may include support for any of the Wi-Fi® standards, including Wi-Fi® 4, Wi-Fi® 5, Wi-Fi® 6E, etc., and/or may support dense IoT deployments. In some instances, the system 100 may be scalable to include additional access points, stations, and/or other devices included therein.

In some instances, the AP processing device 124 may allocate, at the AP 120, a third bandwidth in a third operating band. The third operating band may be one or more of a 2.4 GHz band, a 5 GHz band, or a 6 GHz band. The third operating band may be different from the first operating band and the second operating band supported by the AP 120. The AP processing device 124 may switch, at the AP 120, traffic between the first operating band, the second operating band, and/or the third operating band.

In some instances, the data load between the operating bands (e.g., the first operating band, the second operating band, and/or the third operating band) may be managed by the AP processing device 124. The AP processing device 124 may distribute a data load between the first operating band and the second operating band to prevent congestion in either of the operating bands. In some instances, the data load may be distributed to reduce and/or prevent congestion and ensure performance across connected devices, such as the STA 110, factory machinery, smart TVs, etc. In some instances, the AI/ML software 126 may be operable to intelligently distribute the data load across operating bands to mitigate congestion and maintain throughput.

The AP processing device 124 may be operable support MU-MIMO and/or similar wireless technologies. In some instances, the AP processing device 124 may support advanced MU-MIMO for simultaneous communication with multiple devices, which may improve efficiency in the system 100. The AP processing device 124 may support concurrent multi-band connectivity with 2×2.4 GHz and 2×5/6 GHz MU-MIMO streams that may achieve up to 2 Gbps throughput with latency as low as 10 ms or lower.

In some instances, data transmitted to the STA 110 may be replicated across different operating bands, which may provide redundancy and/or enhance robustness in the system 100. For example, the AP processing device 124 may send, from the AP 120 to the STA 110, a replicated traffic packet on both the first operating band and the second operating band.

Alternatively, or additionally, traffic from the AP 120 to the STA 110 may be switched between the operating bands supported by the AP 120 to enhance performance of the system 100. For example, the AP processing device 124 may switch the traffic between the operating bands to maximize performance for the STA 110. In some instances, traffic switching may be used by the AP processing device 124 to prevent failure of transmissions from the AP 120 to the STA 110. For example, the switching of the traffic by the AP processing device 124 may occur during failover of the system 100.

In some instances, the AP 120 may include a dynamic failover mechanism that may intelligently switch traffic between the operating bands. For example, in some instances, the AI/ML software 126 may intelligently switch the traffic and/or may select optimal packet routes between the AP 120 and the STA 110 for uninterrupted performance. In some instances, the AP processing device 124 and/or the processing device 114 may be operable to switch between the first operating band and the second operating band when failover occurs. For some traffic, packets may be replicated across two or more operating bands contributing to a robust delivery of packets from the AP 120 to the STA 110.

In some instances, security in the AP 120 may be enhanced. For example, one or more of Wi-Fi® protected access 3(WPA 3 ) encryption, over the air (OTA) updates, or an additional layer of end-to-end encryption may be used in the AP 120 and/or communications from the AP 120. Stated another way, the security of the AP 120 may use WPA3 encryption, OTA updates, and/or an additional layer of end-to-end encryption for wired and wireless data transmissions therefrom. Such security measures may ensure enhanced security through WPA3 encryption, OTA updates, and extra end-to-end encryption for sensitive wired and wireless data and/or may protect devices and data in the system 100.

In some instances, the AI/ML software 126 may be used for one or more of real time analytics, resource optimization, computer vision, or predictive maintenance in the system 100 and/or the AP 120. In some instances, edge AI/ML hardware may be integrated in the AP 120 for advanced real-time applications such as predictive analytics and computer vision, compatible with frameworks like PyTorch and TensorFlow or ffmpeg, Opency Computer vision applications. Alternatively, or additionally, cloud AI/ML may be used with reliable Wi-Fi® connectivity in the system 100. For example, in instances in which redundant, concurrent dual-band is used, such as MU-MIMO (e.g., 4×2.4 GHz and 4×5/6 GHz), throughput may be up to 2 Gbps with a latency of about 10 ms. Alternatively, or additionally, various video encoders and decoders may be used in the system 100, including MPEG-1, MPEG-2, H.264 of the like in 480p or 720p. In some instances, the AI/ML software 126 may be used to provide seamless integration with third-party platforms (e.g., Amazon Alexa, and the like) and/or industrial-grade monitoring systems.

In some instances, the processing device 114 may be operable to connect the STA 110 to a first operating band and/or to a second operating band from the AP 120. For example, the processing device 114 may configure the transceiver 112 for communications using the first operating band and/or the second operating band. The first operating band may be one or more of a 2.4 GHz band, a 5 GHz band, or a 6 GHz band and the second operating band may be one or more of a 2.4 GHz band, a 5 GHZ band, or a 6 GHz band. In some instances, the first operating band may be different from the second operating band. The processing device 114 may select a packet from one or more of the first operating band or the second operating band based on performance. In some instances, the processing device 114 may support simultaneous multi-band connections, which may allow for redundancy and reliability (e.g., for use in industrial equipment and consumer devices) in the STA 110. The processing device 114 may redundantly and/or dynamically select packets from either operating band based on performance, which may contribute to ensuring low latency and/or reliable transmissions between the STA 110 and the AP 120. In some instances, dynamic traffic management may contribute to the throughput for demanding applications, such as streaming, gaming, and/or IoT operations.

In some instances, the processing device 114 may be operable to connect to a third operating band. The third operating band may be one or more of a 2.4 GHz band, a 5 GHz band, or a 6 GHz band. Alternatively, or additionally, the third operating band may be different from the first operating band and/or the second operating band.

In some instances, the STA 110 may be operable to use replicated acknowledgments (ACKs) that may be sent to the AP 120 on different operating bands to increase robustness and/or decrease latency in the system 100. For example, the processing device 114 may send, from the STA 110 to the AP 120, a first ACK on the first operating band and a second ACK on the second operating band. The first ACK and the second ACK may be acknowledgments for the same message from the AP 120. In some instances, t redundant acknowledgments (ACKs) may prioritize the earliest response, reducing latency and/or enhancing communication reliability in the system 100. For example, the earliest response may be used to enhance reliability in the system 100 In some instances, the connection ports 116 may be operable to facilitate connections of various devices to the STA 110. In some instances, the connection ports 116 may include a universal serial bus (USB) port such as USB 3.0. Alternatively, or additionally, the connection ports 116 may include an Ethernet port, such as Gigabit Ethernet. In some instances, the system 100 may include a camera connected to the STA 110 via the connection ports 116 (e.g., the USB 3.0 port) and/or an industrial machine connected to the STA 110 via the connection ports 116 (e.g., the Gigabit Ethernet port). In an example, the connection ports 116 may include a 1 GHz Ethernet port and/or a 5 GHz Ethernet port.

Modifications, additions, or omissions may be made to the system 100 without departing from the scope of the present disclosure. For example, in some instances, the AP 120 may include support for various connectivity options, including 1G Ethernet (five ports), USB 3.0, and Wi-Fi® mesh networking. In another example, the STA 110 may include a flash drive and/or the processing device 114 may be a raspberry PI central processing unit. In another example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

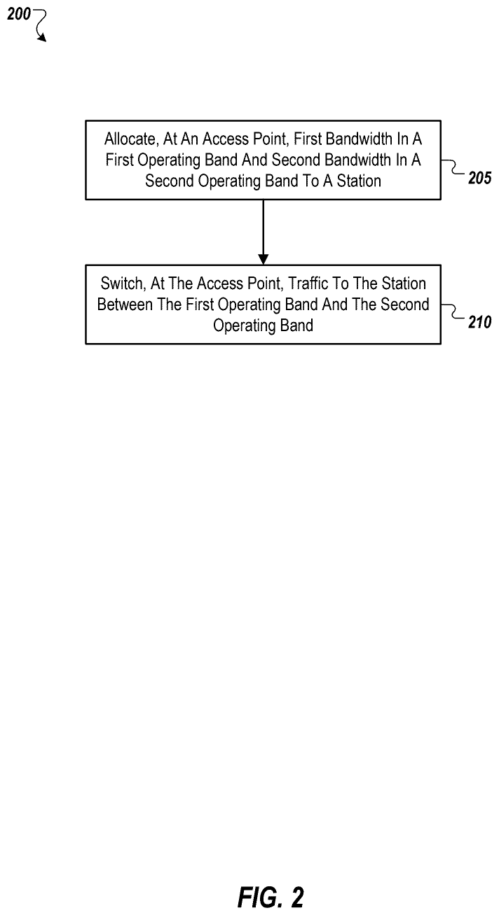

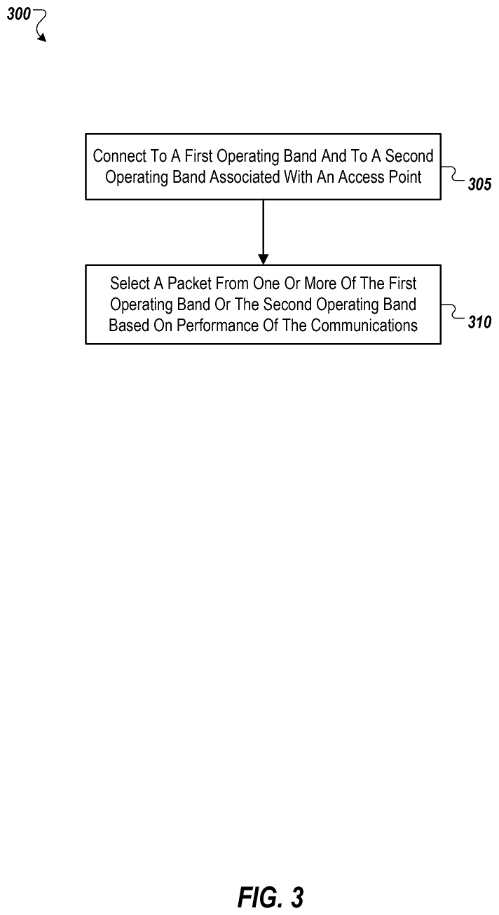

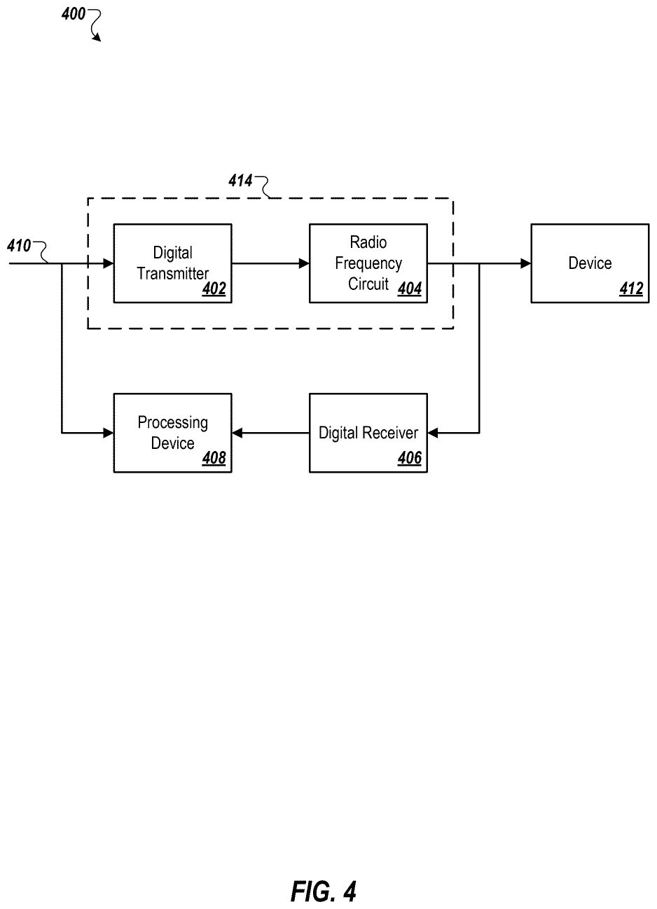

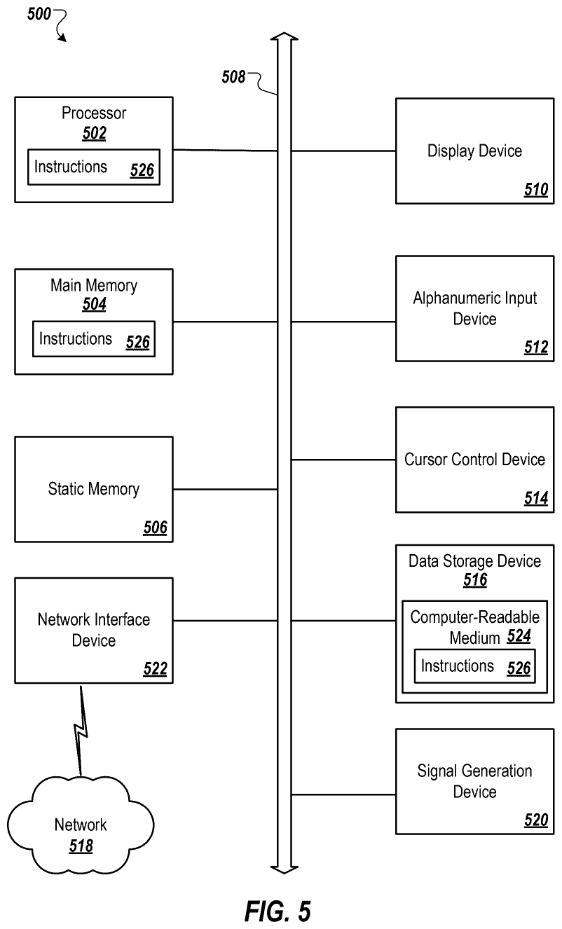

FIGS. 2 and 3 illustrate methods 200 and 300, respectively, which may be performed by processing logic that may include hardware (circuitry, dedicated logic, etc.), software (such as is run on a general purpose computer system or a dedicated machine), or a combination of both, which processing logic may be included in any computer system or device such as the AP 120 of FIG. 1, the communication system 400 of FIG. 4, and/or the processing device 502 of FIG. 5.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 2 illustrates a flowchart of an example method 200 for a Wi-Fi® access point for industrial and consumer internet of things. The method 200 may begin at block 205 where the processing logic may allocate first bandwidth in a first operating band and second bandwidth in a second operating band to a STA. In some instances, the first bandwidth and the second bandwidth may be allocated at an AP. In some instances, the first operating band may be one or more of a 2.4 GHz band, a 5 GHz band, or a 6 GHz band. The second operating band may be one or more of a 2.4 GHz band, a 5 GHz band, or a 6 GHz band. In some instances, the first operating band may be different from the second operating band.

At block 210, the processing logic may switch traffic to the STA between the first operating band and the second operating band. In some instances, the switching may be performed at the AP. In some instances, the switching may occur during failover. Alternatively, or additionally, the switching may maximize performance for the STA.

Modifications, additions, or omissions may be made to the method 200 without departing from the scope of the present disclosure. For example, the processing logic may allocate third bandwidth in a third operating band at the AP. The third operating band may be one or more of a 2.4 GHz band, a 5 GHz band, or a 6 GHz band. Alternatively, or additionally, the third operating band may be different from the first operating band and/or the second operating band. In some instances, the processing logic may switch traffic between the second operating band and the third operating band at the AP.

In another example, the processing logic may distribute a data load between the first operating band and the second operating band to prevent congestion in the first bandwidth and the second bandwidth. In some instances, the data load may be distributed at the AP.

In another example, the processing logic may transmit a replicated traffic packet using the first operating band and the second operating band. In some instances, the replicated traffic packet may be transmitted from the AP to the STA.

In another example, the designations of different elements in the manner described is meant to help explain concepts described herein and is not limiting. Further, the method 200 may include any number of other elements or may be implemented within other systems or contexts than those described.

FIG. 3 illustrates a flowchart of an example method 300 for Wi-Fi® gateway and extender placement optimization. The method 300 may begin at block 305 where the processing logic may connect a STA to a first operating band and to a second operating band associated with an AP. In some instances, the first operating band may be one or more of a 2.4 GHz band, a 5 GHz band, or a 6 GHz band. The second operating band may be one or more of a 2.4 GHz band, a 5 GHz band, or a 6 GHz band. The first operating band may be different from the second operating band.

At block 310, the processing logic may select a packet from one or more of the first operating band or the second operating band based on performance of the communications.

Modifications, additions, or omissions may be made to the method 200 without departing from the scope of the present disclosure. For example, the processing logic may connect to a third operating band. The third operating band may be one or more of a 2.4 GHz band, a 5 GHz band, or a 6 GHz band. The third operating band may be different from the first operating band and/or the second operating band.

In another example, the processing logic may transmit a first ACK on the first operating band and a second ACK on the second operating band. The first ACK and/or the second ACK may be transmitted from the STA to the AP. In some instances, the first ACK and/or the second ACK may be acknowledgments for the same message.

In another example, the processing logic may switch between the first operating band and the second operating band when failover may occur. In another example, the designations of different elements in the manner described is meant to help explain concepts described herein and is not limiting. Further, the method 300 may include any number of other elements or may be implemented within other systems or contexts than those described.

FIG. 4 illustrates a block diagram of an example communication system 400 for a Wi-Fi® access point for industrial and consumer internet of things. The communication system 400 may include a digital transmitter 402, a radio frequency circuit 404, a digital receiver 406, a processing device 408, and a device 412. The digital transmitter 402 and/or the processing device 408 may be configured to receive a baseband signal via a connection 410. In some instances, the digital transmitter 402 and the radio frequency circuit 404 may be a transceiver 414.

In some instances, the communication system 400 may include a system of devices that may be configured to communicate with one another via a wired or wireline connection. For example, a wired connection in the communication system 400 may include one or more Ethernet cables, one or more fiber-optic cables, and/or other similar wired communication mediums. Alternatively, or additionally, the communication system 400 may include a system of devices that may be configured to communicate via one or more wireless connections. For example, the communication system 400 may include one or more devices configured to transmit and/or receive radio waves, microwaves, ultrasonic waves, optical waves, electromagnetic induction, and/or similar wireless communications. Alternatively, or additionally, the communication system 400 may include combinations of wireless and/or wired connections. In these and other examples, the communication system 400 may include one or more devices that may be configured to obtain a baseband signal, perform one or more operations to the baseband signal to generate a modified baseband signal, and transmit the modified baseband signal, such as to one or more loads.

In some instances, the communication system 400 may include one or more communication channels that may communicatively couple systems and/or devices included in the communication system 400. For example, the transceiver 414 may be communicatively coupled to the device 412.

In some instances, the transceiver 414 may be configured to obtain a baseband signal. For example, as described herein, the transceiver 414 may be configured to generate a baseband signal and/or receive a baseband signal from another device. In some examples, the transceiver 414 may be configured to transmit the baseband signal. For example, upon obtaining the baseband signal, the transceiver 414 may be configured to transmit the baseband signal to a separate device, such as the device 412. Alternatively, or additionally, the transceiver 414 may be configured to modify, condition, and/or transform the baseband signal in advance of transmitting the baseband signal. For example, the transceiver 414 may include a quadrature up-converter and/or a digital to analog converter (DAC) that may be configured to modify the baseband signal. Alternatively, or additionally, the transceiver 414 may include a direct radio frequency (RF) sampling converter that may be configured to modify the baseband signal.

In some instances, the digital transmitter 402 may be configured to obtain a baseband signal via the connection 410. In some examples, the digital transmitter 402 may be configured to up-convert the baseband signal. For example, the digital transmitter 402 may include a quadrature up-converter to apply to the baseband signal. In some examples, the digital transmitter 402 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 402.

In some instances, the transceiver 414 may include one or more subcomponents that may be used in preparing the baseband signal and/or transmitting the baseband signal. For example, the transceiver 414 may include an RF front end (e.g., in a wireless environment) which may include a power amplifier (PA), a digital transmitter (e.g., the digital transmitter 402), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., the radio frequency circuit 404) of the transceiver 414 may be synchronized with the resource controller via the S-plane device, which may contribute to high-accuracy timing with respect to a reference clock.

In some instances, the transceiver 414 may be configured to obtain the baseband signal for transmission. For example, the transceiver 414 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 414 may be configured to generate a baseband signal for transmission. In these and other examples, the transceiver 414 may be configured to transmit the baseband signal to another device, such as the device 412.

In some instances, the device 412 may be configured to receive a transmission from the transceiver 414. For example, the transceiver 414 may be configured to transmit a baseband signal to the device 412.

In some instances, the radio frequency circuit 404 may be configured to transmit the digital signal received from the digital transmitter 402. In some examples, the radio frequency circuit 404 may be configured to transmit the digital signal to the device 412 and/or the digital receiver 406. In some examples, the digital receiver 406 may be configured to receive a digital signal from the RF circuit and/or send a digital signal to the processing device 408.

In some instances, the processing device 408 may be a standalone device or system, as illustrated. Alternatively, or additionally, the processing device 408 may be a component of another device and/or system. For example, in some examples, the processing device 408 may be included in the transceiver 414. In instances in which the processing device 408 is a standalone device or system, the processing device 408 may be configured to communicate with additional devices and/or systems remote from the processing device 408, such as the transceiver 414 and/or the device 412. For example, the processing device 408 may be configured to send and/or receive transmissions from the transceiver 414 and/or the device 412. In some examples, the processing device 408 may be combined with other elements of the communication system 400.

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over the network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

1. An access point (AP), comprising:
a transceiver operable to facilitate communications with a station (STA); and
a processing device operable to:
allocate first bandwidth in a first operating band and second bandwidth in a second operating band to the STA; and
switch traffic to the STA between the first operating band and the second operating band,
wherein:
the first operating band is one of a 2.4 GHz band, a 5 GHz band, or a 6 GHz band;
the second operating band is one of a 2.4 GHz band, a 5 GHz band, or a 6 GHz band; and
the first operating band is different from the second operating band.

2. The AP of claim 1, wherein the processing device is further operable to allocate third bandwidth in a third operating band,
wherein:
the third operating band is one of a 2.4 GHz band, a 5 GHz band, or a 6 GHz band; and
the third operating band is different from the first operating band and the second operating band.

3. The AP of claim 2, wherein the processing device is further operable to switch, at the AP, traffic between the first operating band and the third operating band or between the second operating band and the third operating band.

4. The AP of claim 1, wherein the processing device is further operable to distribute a data load between the first operating band and the second operating band to prevent congestion in the first bandwidth and the second bandwidth.

5. The AP of claim 1, wherein the processing device is further operable to transmit a replicated traffic packet using the first operating band and the second operating band.

6. The AP of claim 1, wherein switching the traffic maximizes performance for the STA.

7. The AP of claim 1, wherein switching the traffic occurs during failover.

8. The AP of claim 1, wherein one or more of Wi-Fi® protected access 3(WPA 3 ) encryption, over the air (OTA) updates, or an additional layer of end-to-end encryption is used.

9. The AP of claim 1, wherein artificial intelligence is used by the AP for one or more of real time analytics, resource optimization, computer vision, or predictive maintenance.

10. A station (STA), comprising:
a transceiver operable to facilitate communications with an access point (AP); and
a processing device operable to:
connect to a first operating band and to a second operating band associated with the AP; and
select a packet from one or more of the first operating band or the second operating band
based on performance of the communications,
wherein:
the first operating band is one or more of a 2.4 GHz band, a 5 GHz band, or a 6 GHz band;
the second operating band is one of a 2.4 GHz band, a 5 GHz band, or a 6 GHz band; and
the first operating band is different from the second operating band.

11. The STA of claim 10, wherein the processing device is further operable to connect to a third operating band,
wherein:
the third operating band is one of a 2.4 GHz band, a 5 GHz band, or a 6 GHz band; and
the third operating band is different from the first operating band and the second operating band.

12. The STA of claim 10, wherein the processing device is further operable to transmit, from the STA to the AP, a first acknowledgment (ACK) on the first operating band and a second ACK on the second operating band, wherein the first ACK and the second ACK are acknowledgments for the same message.

13. The STA of claim 10, wherein the processing device is further operable to switch between the first operating band and the second operating band when failover occurs.

14. A method, comprising:
allocating, at an access point (AP), first bandwidth in a first operating band and second bandwidth in a second operating band to a station (STA); and
switching, at the AP, traffic to the STA between the first operating band and the second operating band,
wherein:
the first operating band is one of a 2.4 GHz band, a 5 GHz band, or a 6 GHz band;
the second operating band is one of a 2.4 GHz band, a 5 GHz band, or a 6 GHz band; and
the first operating band is different from the second operating band.

15. The method of claim 14, wherein switching the traffic occurs during failover.

16. The method of claim 14, further comprising allocating, at the AP, third bandwidth in a third operating band,
wherein:
the third operating band is one or more of a 2.4 GHz band, a 5 GHz band, or a 6 GHz band; and
the third operating band is different from the first operating band and the second operating band.

17. The method of claim 16, further comprising switching, at the AP, traffic between the first operating band and the third operating band or between the second operating band and the third operating band.

18. The method of claim 14, further comprising distributing, at the AP, a data load between the first operating band and the second operating band to prevent congestion in the first bandwidth and the second bandwidth.

19. The method of claim 14, further comprising transmitting, from the AP to the STA, a replicated traffic packet using the first operating band and the second operating band.

20. The method of claim 14, wherein switching the traffic maximizes performance for the STA.
